(19) United States
(12) Patent Application Publication
(10) Pub. No.: US 2009/0223114 A1
(43) Pub. Date: Sep. 10, 2009

(54) Live bait trap and bucket

(75) Inventors: Rob Obrien, Ajax (CA); Mark Ladislao, Mississauga (CA); J. Todd Anderson, Oakville (CA)

Correspondence Address: COHEN, PONTANI, LIEBERMAN & PAVANE LLP, 551 FIFTH AVENUE, SUITE 1210, NEW YORK, NY, 10176, US

(73) Assignee: Spin Master Ltd., Toronto (CA)

(21) Appl. No.: 12/075,253

(22) Filed: Mar. 10, 2008

(51) Int. Cl. A01K 69/06; A01K 97/04

(52) U.S. Cl. 43/100; 43/56

(57) ABSTRACT

An apparatus for trapping live bait and storing the captured bait for later use. The bait trap is submerged in water and small bait creatures enter through a funnel-shaped entrance that gradually tapers to a small opening, which prevents escape once bait has entered the trap. Strategic placement of the small opening and drain holes allow the trap to be used as a storage bucket once bait is captured. Access and transportation are provided by a top-mounted door and carrying handle.

### BACKGROUND OF THE INVENTION

1. Field of the Invention

The present invention relates to a live bait trap and bucket. Specifically, it relates to an apparatus for trapping various aquatic creatures, which are commonly used as live fishing bait. Furthermore, the live bait trap and bucket can also be used for storing the captured bait before use.

2. Description of Related Art

There are a number of existing devices for storing live bait, for the purpose of fishing. One such device is described in U.S. Pat. No. 5,529,204 to Sykes, which describes a minnow bucket that has holes to allow the bucket to sink underwater when filled with live bait. This minnow bucket has a spring loaded access door and is selectively floatable by having compartments capable of receiving different materials to affect the overall density of the bucket. However, this invention serves the singular purpose of storing live bait.

U.S. Pat. No. 7,017,297 to Ward describes another bait bucket, which has holes situated in the top half of the bucket to allow it to sink when placed in water and drain while keeping a reservoir for live bait when removed from the water. However, as noted above in the patent to Sykes, this only serves the purpose of storing the live bait once it has been acquired.

There are also a number of devices for capturing live bait, such as those described in U.S. Design Pat. No. D459,781 to Rowley and U.S. Pat. No. 3,906,654 to Leslie. These references describe minnow traps consisting of mesh enclosures accessed by a small hole, which is large enough to allow only typical live bait to enter. Once trapped inside, the singular small opening makes exit rather difficult for the captured live bait. However, when removed from the water, all water drains through the mesh of the trap and does not leave a reservoir in which the captured fish may survive. Therefore, these references only provide an apparatus for trapping live bait and not storing it alive once captured and removed from the water.

An angler who wishes to both trap and fish with live bait is, therefore, forced to use two separate devices. Accordingly, there is a need for an apparatus capable of effectively trapping aquatic bait creatures, with the capability of storing and transporting the captured bait alive until needed for fishing.

### SUMMARY OF THE INVENTION

The present live bait trap and bucket addresses the above problems by combining two commonly used pieces of fishing equipment. During use, the live bait trap and bucket is submersed sideways in a water source, where it slowly fills with water by means of drain holes located in the upper half and a funnel-shaped mouth which may be located on the bottom of the apparatus, and which culminates in a small opening. Typically some food material, such as dog food or pieces of bread, is placed within the trap before submersion in water. The apparatus can be secured to a shore structure by means of a long string and string handle, which is tied to the carrying handle. When not in use the string may be wound upon a spool section on the string handle for storage.

As the apparatus fills with water, the food material placed inside becomes saturated and slowly dissolves into small food particles, which gradually disperse around the flooded interior of the apparatus. Eventually, small aquatic bait creatures such as minnows, tadpoles, small frogs, or other bait fish will be attracted to the suspended food particles and enter through the small opening at the end of the funnel-shaped mouth on the bottom of the apparatus. The small opening is sized such that only small creatures useful as fishing bait can enter the apparatus to feed.

Once the small bait creatures have entered the interior of the apparatus, exit will be difficult as the small opening prevents easy egress to the surrounding water source. After an adequate amount of bait has been trapped, the apparatus can be removed from the water for use as a bucket to store the captured live bait. Water drains out of the aforementioned drain holes and small opening in the funnel-shaped mouth at the bottom, until the water has receded to a level nominally below the level of the drain holes and the funnel-shaped mouth. The water is contained within the bottom half of the apparatus, allowing the bait to remain alive during storage and transport for use in live bait fishing. The live bait trap and bucket is then transported by means of a carrying handle, which further serves the purpose of securing the top lid to the bottom section by means of interlocking cylindrical tabs oriented through holes in the bottom section and forcibly snap-fitted into holes on the top lid.

When live bait is required, the angler opens the access door located in the lid of the apparatus and reaches inside to retrieve the bait of choice. After retrieval, the access door is secured again by means of sliding interlocking tabs.

According to one aspect then, there is provided a bait trap submergible in water for catching and storing small aquatic bait creatures, the bait trap comprising: a bottom section with an open top end and a bottom end; and a top section secured to and closing the top end of the bottom section forming a generally cylindrical enclosure, the bottom section including at least one entrance hole opening into the interior of the enclosure, the entrance hole being large enough to allow the small aquatic bait creatures to enter into the cylindrical enclosure when the bait trap is submerged in water, yet small enough to hinder exit of the bait creatures from the cylindrical enclosure, the entrance hole being positioned within the bottom section at a level between the top end and the bottom end such that when the bait trap is removed from the water and held in an upright position, a sufficient amount of water is retained in the bait trap to ensure survival of the small aquatic bait creatures.

In other aspects, the entrance hole may be funnel-shaped, tapering inwardly toward the interior of the enclosure. The top section of the bait trap may include an access door for accessing the interior of the enclosure to remove the bait creatures or add food, the access door interlocking with the top section by means of mating tabs. The access door may have a tether for attaching it to the top section, and the bait trap may also include a carrying handle, the carrying handle having locking tabs which pass through mating holes in the top section and the bottom section thereby securing the top section to the bottom section and to the handle. The bottom section includes a plurality of drain holes adjacent the top end of the bottom section, the drain holes being positioned above the level of the entrance hole. The drain holes being of a size suitable for letting water flow into and out of the enclosure, but small enough to keep the bait creatures from exiting the enclosure. The bait trap may include a tether for attachment to a secure structure, and a handle, including a spool section for storing the tether when not in use. Advantageously, the top section may contain a plurality of drain holes and the access door may include a hand grip to assist in opening and closing the access door. The funnel-shaped entrance hole may be in the range of one inch in diameter and located in the bottom end of the bottom section, tapering upward from the bottom end towards the top end.

According to a further aspect, there is provided a bait trap submergible in water for catching and storing small aquatic bait creatures, the bait trap comprising: a bottom section with an open top end and a bottom end; and a top section secured to and closing the top end of the bottom section forming a generally cylindrical enclosure, the bottom section including at least one funnel-shaped mouth which tapers to an entrance hole opening into the interior of the enclosure, the entrance hole being large enough to allow the small aquatic bait creatures to enter into the cylindrical enclosure when the bait trap is submerged in water, yet small enough to hinder exit of the bait creatures from the cylindrical enclosure, the entrance hole being positioned within the bottom section at a level between the top end and the bottom end such that when the bait trap is removed from the water and held in an upright position, a sufficient amount of water is retained in the bait trap to ensure survival of the small aquatic bait creatures. Advantageously, the funnel-shaped mouth may be located in the bottom end of the bottom section and tapers upward from the bottom end towards the top end.

It is to be understood that other aspects of the present live bait trap and bucket will become readily apparent to those skilled in the art from the following detailed description, wherein various embodiments are shown and described by way of illustration. As will be realized, the live bait trap and bucket is capable of other and different embodiments and its several details are capable of modification in various other respects, all without departing from the spirit and scope of the live bait trap and bucket described. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the live bait trap and bucket are illustrated by way of example, and not by way of limitation, in detail in the figures, wherein:

FIG. 1 is a perspective view of one embodiment of the live bait trap and bucket.

FIG. 1a is a side perspective, semi-transparent view of another embodiment of the live bait trap and bucket, showing the string handle and rubber tether attached, and showing the funnel shaped mouth. p FIG. 2 is a plan view of the string handle for the live bait trap and bucket.

FIG. 3 is a plan view of the rubber tether for the live bait trap and bucket.

FIG. 4 is a perspective view of the carrying handle for the live bait trap and bucket.

FIG. 5 is a cross-sectional view of the bottom section of the live bait trap and bucket.

FIG. 6 is a bottom plan view of the bottom section of the live bait trap and bucket.

### DETAILED DESCRIPTION OF THE PRESENTLY PREFERRED EMBODIMENTS

The live bait trap and bucket shall be described with reference to specific embodiments. Similar numerals are used in all figures to refer to similar components.

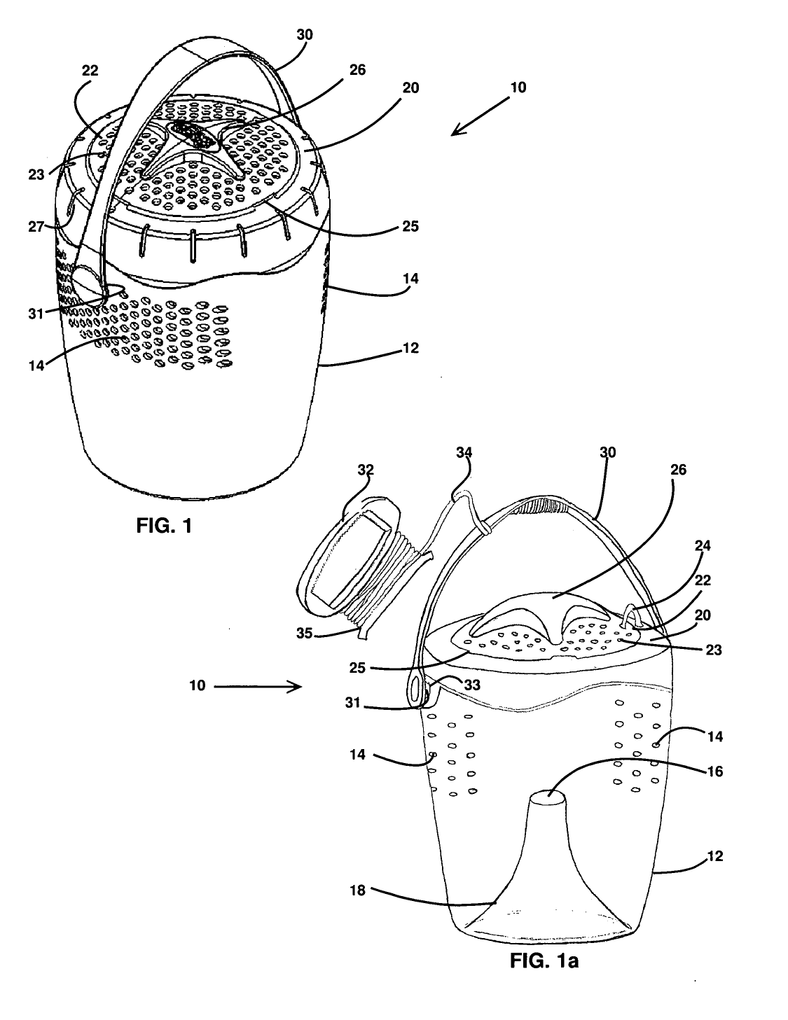

With reference to FIGS. 1 and 1a, the live bait trap and bucket is generally indicated by the numeral 10. The apparatus comprises a cylindrical lid 20, a bottom section 12, and a carrying handle 30.

The live bait trap and bucket 10 is formed when the cylindrical lid 20, is fitted together with the bottom section 12, forming a generally cylindrical enclosure.

The bottom section 12, includes an open top end 15 and a bottom end 17 (see FIG. 6) and may contain a plurality of drain holes 14 adjacent the top end 15. At least one funnel shaped mouth 18 (see FIGS. 1a, 5 and 6) tapers inward to culminate in a small entrance hole 16 opening into the interior of the bottom section 12. The entrance hole 16 needs to be large enough to allow the small aquatic bait creatures to enter into the bottom section 12 yet small enough to hinder their exit from the enclosure. A suitable-diameter is in the range of about one inch (2.5 cm). The entrance hole 16 also needs to be positioned within the bottom section 12 at a point between the top end 15 and the bottom end 17 such that when the bait trap is removed from the water and held in an upright position, a sufficient amount of water will be retained in the bait trap to ensure survival of the small aquatic bait creatures.

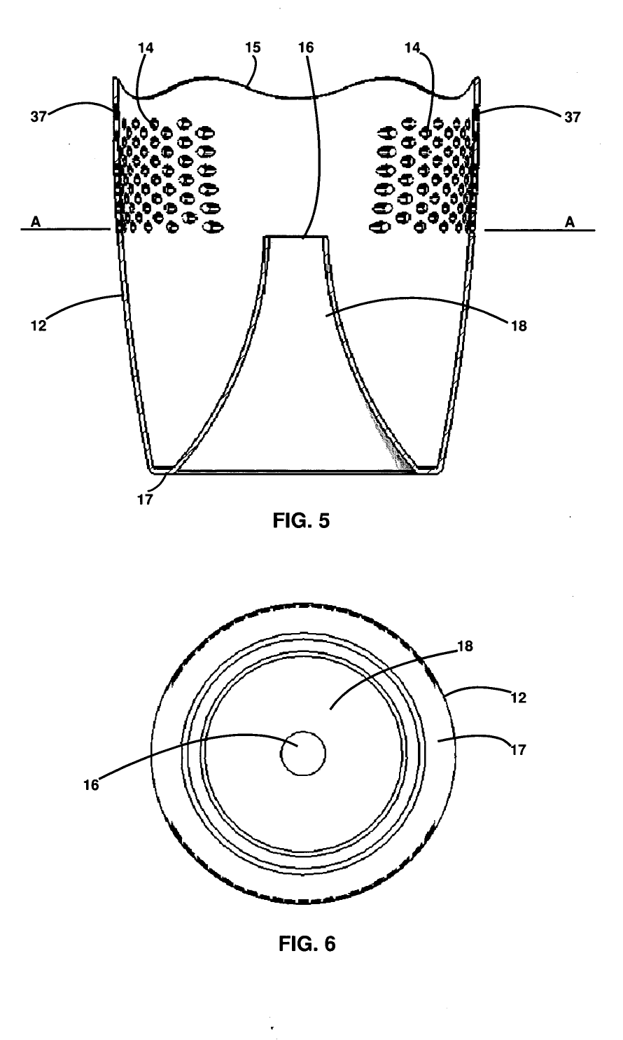

In the embodiment shown in FIGS. 1 and 1a, the funnel shaped mouth tapers upward from the bottom end 17 towards the top end 15 and the entrance hole 16 is located at a level A (see FIG. 5) between about four to five inches above the bottom end 17. The plurality of drain holes 14 in the bottom section 12 extend from a position adjacent the top end 15 down to approximately the level A of the small opening 16. The drain holes 14 are not essential, but will assist in allowing water to more rapidly move into and out of the bait trap when it is placed into and removed from the water.

The cylindrical lid 20, contains an access door 22. The access door 22 may contain a further plurality of drain holes 23, a formed hand grip 26, and slidably interlocking tabs 25, which serve to secure the access door 22 to the cylindrical lid 20 when in the closed position. Additional drain holes or slots 27 may be included in the lid 20.

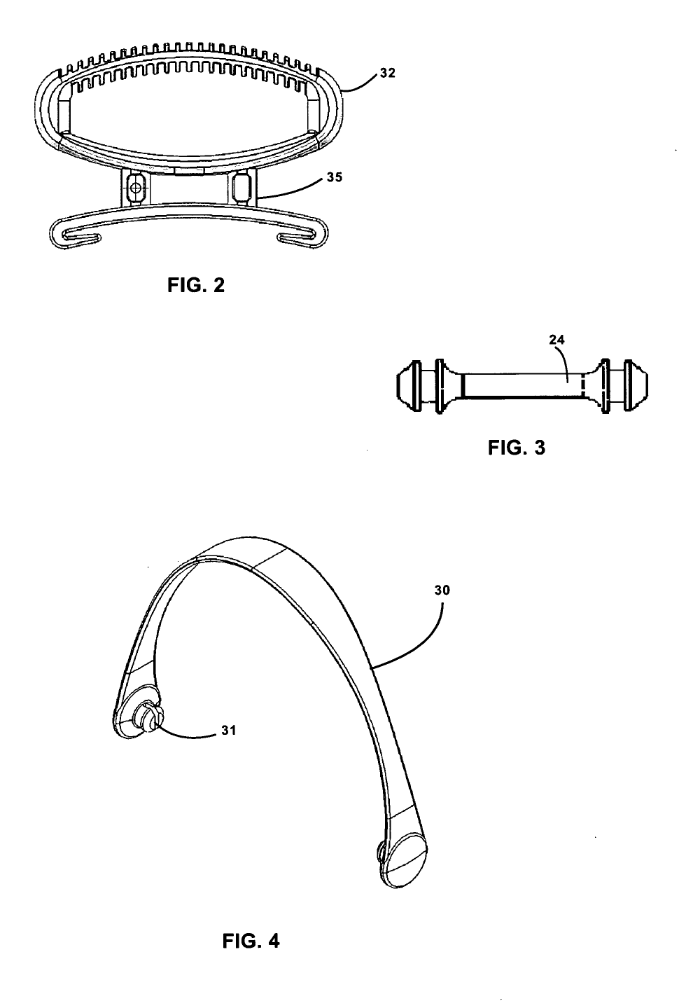

The access door 22 may be tethered to the cylindrical lid 20, which may be accomplished using a door tether 24 (see FIGS. 1a and 3), fitted into adjacent holes in the cylindrical lid 20 and access door 22. Door tether 24 may advantageously be made of rubber or some other flexible material.

In one embodiment, the carrying handle 30 mounts to the cylindrical lid 20 and bottom section 12 by means of cylindrical locking tabs 31 (best seen in FIG. 4), which orient through holes 33 in the cylindrical lid 20 and corresponding holes 37 in bottom section 12 to secure the carrying handle to the lid and bottom section.

The live bait trap and bucket 10 may also include a tether 34, such as a rope or string, for attachment to a secure object such as a tree or dock to prevent it from floating or being dragged away by the current. One end of the tether 34 may be tied to the carrying handle 30 while the other end may be secured to a string handle 32, which may contain a spool section 35 (best seen in FIG. 2) for winding the tether 34 for storage when not in use. The string handle 32 may be used to drag the bait trap and bucket 10 through the water to assist in filling it with water, or to retrieve the bait trap and bucket once filled with bait.

In operation, food particles are placed in the bottom section 12 of live bait trap and bucket 10, which is then placed on its side in a body of water suspected of harboring aquatic creatures typically used for live bait fishing. Water enters the live bait trap and bucket 10 by way of the plurality of drain holes 14, 23, 27 and the small opening 16. When the live bait trap and bucket 10 is filled with water, the food particles slowly dissolve and disperse around the interior. Eventually, small aquatic bait creatures enter the live bait trap and bucket 10 by way of the small opening 16 in the funnel shaped mouth 18 in the bottom section 12.

Once placed in the body of water the live bait trap and bucket 10 can be secured to a stationary structure using the string 34 and string handle 32 for easy retrieval. When not in use the string 34 can be stored on the spool section 35.

Once trapped inside, the small aquatic creatures cannot easily escape and furthermore, remain attracted to the food particles remaining within the apparatus. The small opening 16 is shaped such that larger predatory fish cannot enter the live bait trap and bucket 10 to prey on the captured bait. After a suitable amount of time, the live bait trap and bucket 10 can be retrieved from the water by means of the string handle 32 or carrying handle 30. Once removed from the water and positioned upright, water will drain out of the drain holes 14 and the small opening 16 until the water recedes just below the level of the drain holes 14 and small opening 16, allowing a reservoir of water to be retained within the bottom section 12. This allows the captured bait to remain alive within the live bait trap and bucket 10 for transport and storage before use.

When fishing, the user can open the live bait trap and bucket by gripping the formed hand grip 26 and slightly rotating the access door 22 until the slidably interlocking tabs 25 disengage. When opened, the access door 22 remains tethered to the cylindrical lid 20 by means of the rubber tether 24. The bait can then be removed and the access door 22 closed.

The previous detailed description is provided to enable any person skilled in the art to make or use the present live bait trap and bucket. Various modifications to those embodiments will be readily apparent to those skilled in the art, and the generic principles defined herein may be applied to other embodiments without departing from the spirit or scope of the live bait trap and bucket described herein. Thus, the present live bait trap and bucket is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed is:

1. A bait trap submergible in water for catching and storing small aquatic bait creatures, said bait trap comprising:
a bottom section with an open top end and a bottom end; and
a top section secured to and closing said top end of said bottom section forming a generally cylindrical enclosure,
said bottom section including at least one entrance hole opening into the interior of said enclosure,
said entrance hole being large enough to allow the small aquatic bait creatures to enter into the cylindrical enclosure when the bait trap is submerged in water, yet small enough to hinder exit of the bait creatures from said cylindrical enclosure,
said entrance hole being positioned within said bottom section at a level between said top end and said bottom end such that when said bait trap is removed from the water and held in an upright position, a sufficient amount of water is retained in the bait trap to ensure survival of the small aquatic bait creatures.

2. The bait trap of claim 1, wherein said at least one entrance hole is funnel-shaped, said funnel-shape tapering inwardly toward the interior of said enclosure.

3. The bait trap of claim 1, wherein said top section includes an access door for accessing the interior of said cylindrical enclosure to remove the bait creatures or add food.

4. The bait trap of claim 3, including a door tether for attaching said access door to said top section.

5. The bait trap of claim 1, including a carrying handle.

6. The bait trap of claim 1, wherein said bottom section includes a plurality of drain holes adjacent said top end of said bottom section, said drain holes positioned above the level of said entrance hole.

7. The bait trap of claim 1, including a tether for attaching the bait trap to a secure structure.

8. The bait trap of claim 7, wherein said tether is attached to a string handle, said string handle containing a spool section for storing said tether when not in use.

9. The bait trap of claim 3, wherein said access door interlocks with said top section by means of mating tabs.

10. The bait trap of claim 1, wherein said top section contains a plurality of drain holes.

11. The bait trap of claim 3, wherein said access door includes a hand grip to assist in opening and closing said access door.

12. The bait trap of claim 5, wherein said carrying handle includes locking tabs which pass through mating holes in said top section and said bottom section thereby securing said top section to said bottom section and to said handle.

13. The bait trap of claim 2, wherein said at least one funnel-shaped entrance hole is located in said bottom end of said bottom section and tapers upward from said bottom end towards said top end.

14. The bait trap of claim 1, where in said at least one entrance hole is in the range of one inch in diameter.

15. A bait trap submergible in water for catching and storing small aquatic bait creatures, said bait trap comprising:
a bottom section with an open top end and a bottom end; and
a top section secured to and closing said top end of said bottom section forming a generally cylindrical enclosure,
said bottom section including at least one funnel-shaped mouth which tapers to an entrance hole opening into the interior of said enclosure,
said entrance hole being large enough to allow the small aquatic bait creatures to enter into the cylindrical enclosure when the bait trap is submerged in water, yet small enough to hinder exit of the bait creatures from said cylindrical enclosure,
said entrance hole being positioned within said bottom section at a level between said top end and said bottom end such that when said bait trap is removed from the water and held in an upright position, a sufficient amount of water is retained in the bait trap to ensure survival of the small aquatic bait creatures.

16. The bait trap of claim 15, wherein said at least one funnel-shaped mouth is located in said bottom end of said bottom section and tapers upward from said bottom end towards said top end.
